(19) United States
(12) Patent Application Publication
(10) Pub. No.: US 2008/0183966 A1
(43) Pub. Date: Jul. 31, 2008

(54) ELECTRONIC SYSTEM FOR INFORMING TERM-OF-VALIDITY AND/OR ENDURANCE DATA AND METHOD THEREOF

(76) Inventors: Kyu Hyun SHIM, Suwon-si (KR); Nam Phil JO, Hwaseong-si (KR); Sam-Yong BAHNG, Seongnam-si (KR)

Correspondence Address: F. CHAU & ASSOCIATES, LLC, 130 WOODBURY ROAD, WOODBURY, NY, 11797, US

(21) Appl. No.: 11/954,769

(22) Filed: Dec. 12, 2007

(30) Foreign Application Priority Data
Jan. 29, 2007 (KR) 10-2007-0008907

(51) Int. Cl. G06F 12/00

(52) U.S. Cl. 711/115; 711/E12.001

(57) ABSTRACT

An electronic system for informing the term of validity and endurance includes a host and a semiconductor memory card. The semiconductor memory card informs a user of the term of validity and/or the endurance thereof, so that the user can move data stored in the semiconductor memory card to another memory device before the life span of the semiconductor memory card expires based on data about the term of validity and/or the endurance, thereby safely preserving the data.

### CROSS-REFERENCE TO RELATED PATENT APPLICATION

This application claims priority under 35 U.S.C. § 119 from Korean Patent Application No. 2007-0008907, filed on Jan. 29, 2007, the disclosure of which is herein incorporated by reference in its entirety.

### BACKGROUND OF THE INVENTION

1. Field of the Invention

The present invention relates to an electronic system, and more particularly, to an electronic system for informing the term of validity and endurance and a method thereof.

2. Discussion of Related Art

Non-volatile semiconductor memory devices, for example, flash memory devices, can electronically erase and write data. Storage devices based on flash memory have lower power consumption than magnetic disc storage devices and thus have been researched and developed as an alternative to the magnetic disc storage devices.

A data retention period of a single level cell (SLC) flash memory device is about 10 years and a multi-level cell (MIC) flash memory device has a data retention period of about 5 years. As large capacity MIC technology has been introduced, the data retention period has decreased. The data retention period of flash memory devices, that is, the term of validity of the flash memory devices, may vary with the development of technology in the future.

To preserve the data, users need to detect how many days are left in the data retention period of a flash memory device and move data in the flash memory device to another memory device before the data retention period expires. Therefore, a need exists for a flash memory device that informs the users of the term of validity.

In addition, unlike a magnetic disc memory device which can freely overwrite data, a flash memory device cannot overwrite data. Accordingly, in order to overwrite data in the flash memory device, the data must be erased first, returning the memory cells to an initial writable state. Such an operation is referred to as an erase operation. Typically, the flash memory device has three operation modes: a program mode, an erase mode, and a read mode.

The erase operation takes a longer time than the program (or write) operation. Moreover, since the erase operation is typically performed in greater block units than the program or read operation, frequent erase operations increase an erase count of the flash memory device and may significantly affect the life span of the flash memory device. Accordingly, in order to preserve data in the flash memory device, users need to move the data to another memory device before the current erase count of the flash memory device exceeds a limit of the erase count for the product.

While the limit of an erase count of a flash memory device is described in product specifications, it is not easy for users to detect a current erase count of the flash memory device. Therefore, a need exists for a flash memory device that informs the user of the current erase count of the flash memory device or the number of erase operations that can be performed afterwards.

### SUMMARY OF THE INVENTION

According to an embodiment of the present invention, a semiconductor memory card includes a memory unit configured to store term-of-validity data and a memory controller electrically connected with the memory unit and configured to transmit the term-of-validity data to a host in response to a term-of-validity data request signal output from the host.

The memory controller may generate the term-of-validity data based on a manufacturing date input from the host when the term-of-validity data does not exist in the memory unit.

According to an embodiment of the present invention, an electronic system including a memory card configured to store term-of-validity data and a host. The host may transmit a term-of-validity data request signal to the memory card and receive the term-of-validity data.

The memory card may include a memory unit configured to store the term-of-validity data and a memory controller electrically connected with the memory unit and configured to transmit the term-of-validity data to the host in response to the term-of-validity data request signal output from the host.

The host may include an internal circuit unit and a host controller configured to control data input/output between the internal circuit unit and the memory controller and to transmit the term-of-validity data request signal to the memory controller. The internal circuit unit may be electrically connected with the host controller, may generate the term-of-validity data request signal, and may receive the term-of-validity data through the host controller.

The electronic system may further include a display unit configured to display the term-of-validity data.

According to an embodiment of the present invention, a method of providing term-of-validity data of non-volatile memory includes generating a command and an address to detect term-of-validity data in response to a term-of-validity data request signal generated from a host, using a memory controller, and performing one of detecting the term-of-validity data based on the command and the address, wherein the term-of-validity data is transmitted to the memory controller, and generating the term-of-validity data based on manufacturing date information input from the host, using a memory unit, when the term-of-validity data does not exist in a memory unit.

The method may further include transmitting the term-of-validity data request signal generated by an internal circuit unit to the memory controller, using a host controller, before the generation of the command and the address to detect the term-of-validity data, and receiving the term-of-validity data through the host controller, using the internal circuit unit, after the generation of the term-of-validity data.

The method may further include displaying the term-of-validity data using a display unit.

According to an embodiment of the present invention, a semiconductor device includes a memory unit configured to store first endurance data, and a memory controller configured to receive and update the first endurance data, to store updated data as second endurance data, and to transmit the second endurance data to the memory unit or a host.

The memory controller may include an update unit configured to receive and update the first endurance data and to store the updated data as the second endurance data, and a control unit configured to transmit one of the first endurance data and the second endurance data to the host in response to an endurance data request signal output from the host and to transmit the second endurance data to the memory unit.

The update unit may include a memory section configured to store one of the first endurance data and the second endurance data, and an update circuit section configured to receive and update the first endurance data and to transmit the updated data as the second endurance data to the memory section or the control unit.

The first endurance data may indicate the number of available erase operations that can be performed until a life span of the semiconductor device ends. The second endurance data may correspond to a result of subtracting a number of erase operations performed in a given period from the first endurance data.

The memory controller may transmit the second endurance data to the memory unit in response to a power down signal output from the host.

According to an embodiment of the present invention, an electronic system include a memory card configured to update first endurance data and to store updated data as second endurance data, and a host. The host may transmit an endurance data request signal to the memory card and receive one of the first endurance data and the second endurance data.

The memory card may include a memory unit configured to store the first endurance data, and a memory controller configured to receive and update the first endurance data, to store the updated data as the second endurance data, and to transmit the second endurance data to the memory unit or the host.

The memory controller may transmit the second endurance data to the memory unit in response to a power down signal output from the host.

The first endurance data may indicate the number of available erase operations that can be performed until a life span of the memory card ends and the second endurance data may correspond to a result of subtracting a number of erase operations performed in a given period from the first endurance data.

According to an embodiment of the present invention, a method of providing endurance data of non-volatile memory includes the operations of receiving first endurance data from a memory unit, using a memory controller, and receiving and updating the first endurance data, storing updated data as second endurance data, and transmitting the second endurance data to one of the memory unit and a host, using the memory controller.

The operation of receiving and updating the first endurance data, storing the updated data, and transmitting the second endurance data may include receiving and updating the first endurance data and transmitting the updated data as the second endurance data to one of a memory section and the memory unit, using an update circuit section, storing the second endurance data using the memory section or the memory unit, and transmitting one of the first endurance data and the second endurance data to the host in response to an endurance data request signal output from the host, using a control unit.

The first endurance data may indicate the number of available erase operations that can be performed until a life span of the non-volatile memory ends and the second endurance data may correspond to a result of subtracting a number of erase operations performed in a given period from the first endurance data.

### BRIEF DESCRIPTION OF THE DRAWINGS

The present invention will become more apparent by describing in detail exemplary embodiments thereof with reference to the attached drawings in which:

FIG. 1 is a functional block diagram of an electronic system according to an embodiment of the present invention;

FIG. 2 is a functional block diagram of an electronic system according to an embodiment of the present invention;

FIGS. 3A through 3J illustrate electronic devices including the electronic system illustrated in FIG. 1 or 2;

FIG. 4 is a flowchart of a method of providing term-of-validity data according to an embodiment of the present invention; and

FIG. 5 is a flowchart of a method of providing endurance data according to an embodiment of the present invention.

### DETAILED DESCRIPTION OF EXEMPLARY EMBODIMENTS

The present invention now will be described more fully hereinafter with reference to the accompanying drawings, in which embodiments of the invention are shown. This invention may, however, be embodied in many different forms and should not be construed as limited to embodiments set forth herein. Rather, embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

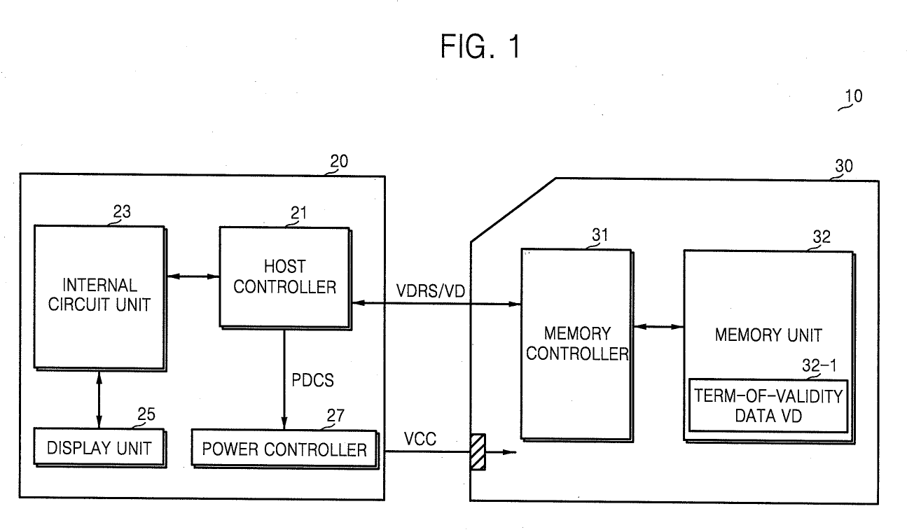

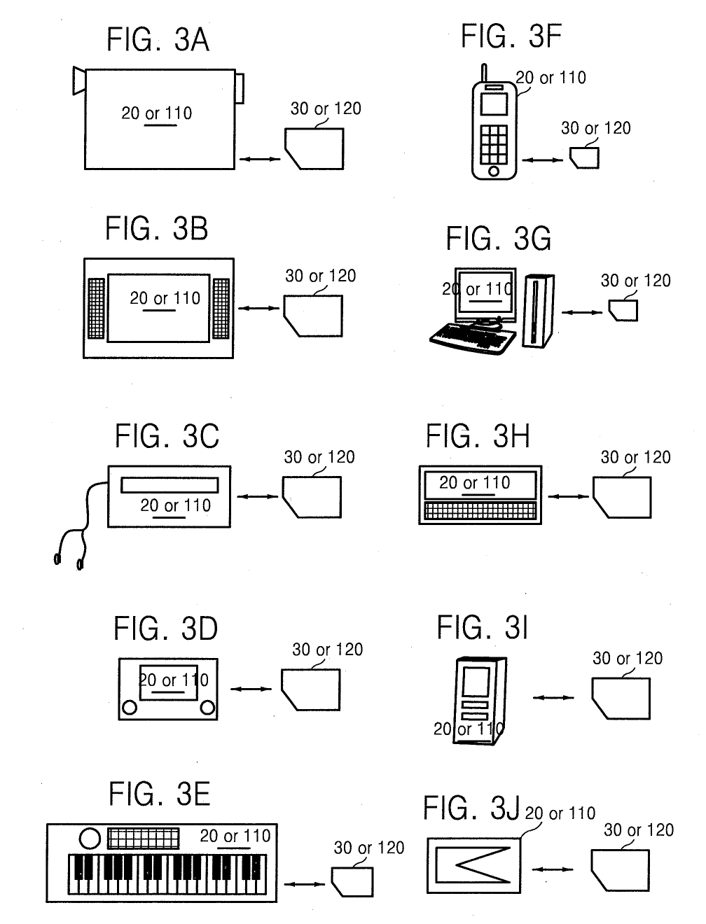

FIG. 1 is a functional block diagram of an electronic system 10 according to some embodiments of the present invention. FIGS. 3A through 3J illustrate electronic devices including the electronic system 10 illustrated in FIG. 1. Referring to FIG. 1 and FIGS. 3A through 3J, the electronic system 10 includes a semiconductor memory card 30 and a host (e.g., an electronic device) 20.

The electronic system 10 may be implemented in a video camera (FIG. 3A), a television (FIG. 3B), an MP3 player (FIG. 3C), a game player (FIG. 3D), an electronic instrument (FIG. 3E), a mobile terminal (FIG. 3F), a personal computer (PC) (FIG. 3G), a personal digital assistant (PDP) (FIG. 3H), a voice recorder (FIG. 3I), a PC card (FIG. 3J) or the like.

The host 20 may be a digital electronic device such as a PC, a PDA, a digital camera, a mobile telephone, a laptop, an MP3 player or the like. The host 20 may include a host controller 21, an internal circuit unit 23, a display unit 25, and a power controller 27. The host controller 21 and the internal circuit unit 23 may be implemented in a single chip.

The semiconductor memory card 30 may include a memory unit 32 and a memory controller 31. The memory unit 32 stores term-of-validity data VD.

The host controller 21 may control data input/output between the internal circuit unit 23 and the memory controller 31 and transmit a term-of-validity data request signal VDRS to the memory controller 31. The host controller 21 may transmit a power down control signal PDCS to the power controller 27 in response to a power down signal (not shown) generated in the internal circuit unit 23. The power down control signal PDCS is a signal for controlling supply or interruption of power, which is supplied to the semiconductor memory card 30 by the power controller 27.

The internal circuit unit 23 is electrically connected between the host controller 21 and the display unit 25. The internal circuit may generate the term-of-validity data request signal VDRS and receive the term-of-validity data VD from the semiconductor memory card 30. The internal circuit unit 23 may generate video or audio data according to a type of the host 20 (e.g., the video camera (FIG. 3A), the television (FIG. 3B), the MP3 player (FIG. 3C), the game player (FIG. 3D), the electronic instrument (FIG. 3E), the mobile terminal (FIG. 3F), the PC (FIG. 3G), the PDP (FIG. 3H), the voice recorder (FIG. 3I), the PC card (FIG. 3J)) or the like. The internal circuit unit 23 may transmit the generated video or audio data to the semiconductor memory card 30 to store the data and may receive the stored video or audio data.

The term-of-validity data VD is information indicating the life span, for example, the data retention period of the semiconductor memory card 30 or the memory unit 32. For example, when the life span of the semiconductor memory card 30 or the memory unit 32 extends to May 5, 2017, the date may be recorded as the term-of-validity data VD at a particular address 32-1 in the memory unit 32.

The term-of-validity data VD may be input to the internal circuit unit 23 via the memory controller 31 in the semiconductor memory card 30 or may be directly input to the internal circuit unit 23 without passing through the memory controller 31. The semiconductor memory card 30 may transmit the term-of-validity data VD based on a command and an address, which are generated by the internal circuit unit 23, without including the memory controller 31.

For example, when the host 20 is the video camera illustrated in FIG. 3A, the semiconductor memory card 30, which does not include the memory controller 31, is a semiconductor memory device (e.g., a flash memory device) embedded in the video camera and may transmit the term-of-validity data VD to the internal circuit unit 23 based on a command and an address generated by the internal circuit unit 23.

The display unit 25 displays the term-of-validity data VD. Users can detect the term of validity of the semiconductor memory card 30 or the memory unit 32 from the term-of-validity data VD displayed by the display unit 25 and can move data stored in the memory unit 32 to another memory device before the term of validity to preserve the data.

The power controller 27 supplies a power supply voltage VCC to the semiconductor memory card 30 and may supply or interrupt the power supply voltage VCC to the semiconductor memory card 30 in response to the power down control signal PDCS generated by the host controller 21. The power supply voltage VCC is supplied to at least one of the memory controller 31 and the memory unit 32 for the operation of the semiconductor memory card 30.

The semiconductor memory card 30 may be electrically connected to a memory slot (not shown) and store data (e.g., video data or audio data) output from the internal circuit unit 23 or transmit stored data to the internal circuit unit 23 via a card interface (not shown) implemented in the host 20. The semiconductor memory card 30 is a memory card removable from the host 20 and may be a compact flash card, a memory stick, a memory stick duo card, a multimedia card (MMC), a reduced MMC, a secure digital (SD) card, a mini SD card, a micro SD card (or a trans flash card), a smart card, an extreme digital (XD) picture card or the like.

Alternatively, the semiconductor memory card 30 may be a memory device embedded in the host 20. For example, when the host 20 is the MP3 player illustrated in FIG. 3C, the semiconductor memory card 30 may be a semiconductor memory device, e.g., a flash memory device, embedded in the MP3 player.

The semiconductor memory card 30 may include a power port input pin for receiving the power supply voltage VCC from the host 20, an address pin for receiving an address of data, a data input/output pin for receiving the data, and a command pin for receiving a command.

The memory unit 32 may be implemented as a non-volatile memory device such as a mask read-only memory (ROM) device, an electrically erasable and programmable ROM (EEPROM) device, a flash memory device (e.g., a NOR flash memory device or a NAND flash memory device), or an erasable and programmable ROM (EPROM) device.

The memory controller 31 is electrically connected with the memory unit 32 and transmits the term-of-validity data VD to the host 20 in response to the term-of-validity data request signal VDRS output from the host 20. When the term-of-validity data VD does not exist in the memory unit 32, the memory controller 31 may generate the term-of-validity data VD based on information about a manufacturing date input from the host 20. For example, when the manufacturing date of the semiconductor memory card 30 or the memory unit 32 is May 5, 2007 and a user inputs the manufacturing date into the internal circuit unit 23 in the host 20 using a user interface (e.g., a keyboard or a mouse (not shown) implemented in the host 20), the memory controller 31 adds the term of validity (e.g., 10 years) stored in the memory controller 31 to the manufacturing date input through the internal circuit unit 23 and the host controller 21 and outputs a result of the addition, i.e., May 5, 2017, as the term-of-validity data VD.

The term-of-validity data VD is transmitted to the memory unit 32 and the term-of-validity data VD stored in the memory unit 32 may be transmitted to the host 20. The term of validity, e.g., 10 years, may be input by a user using a user interface (e.g., a keyboard or a mouse (not shown) implemented in the host 20).

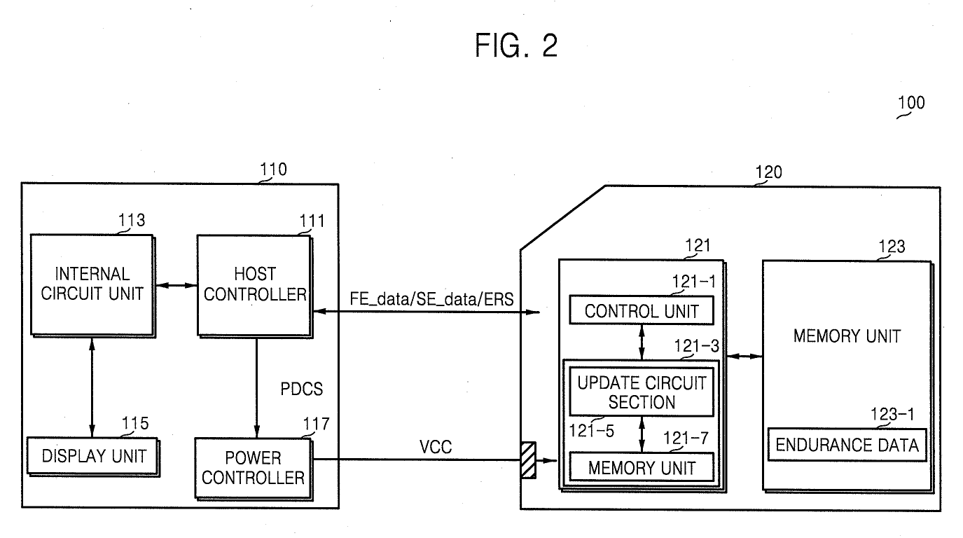

FIG. 2 is a functional block diagram of an electronic system 100 according to an embodiment of the present invention. FIGS. 3A through 3J illustrate electronic devices including the electronic system 100 illustrated in FIG. 2. Referring to FIG. 2 and FIGS. 3A through 3J, the electronic system 100 may include substantially the same structure and functions as the electronic system 10 illustrated in FIG. 1. The electronic system 100 may have a different structure and functions as described herein. Descriptions of the structure and the functions of the electronic system 100, which are the same as or similar to those of the electronic system 10, may be omitted below.

The electronic system 100 includes a host 110 (e.g., an electronic device) and a semiconductor memory card 120. The host 110 may be a digital electronic device such as a PC, a PDA, a digital camera, a mobile telephone, a laptop, or an MP3 player and may include a host controller 111, an internal circuit unit 113, a display unit 115, and a power controller 117.

The semiconductor memory card 120 includes a memory controller 121 and a memory unit 123. The host controller 111 controls input/output of first endurance data FE_data and second endurance data SE_data between the internal circuit unit 113 and the semiconductor memory card 120 and may transmit an endurance data request signal ERS to the semiconductor memory card 120.

The first endurance data FE_data may affect the life span of the semiconductor memory card 120 and may be an erase count of the memory unit 123. The first endurance data FE_data indicates the number of available erase operations that can be performed until the life span of the semiconductor memory card 120 ends. When the memory unit 123 is implemented by a flash memory device, the first endurance data FE_data may indicate the number of erase operations performed in block units. Alternatively, the first endurance data FE_data may indicate an erase count of a block having a maximum erase count among all blocks included in the memory unit 123. For example, when the number of available erase operations that can be performed until the life span of the semiconductor memory card 120 ends (hereinafter, referred to as a valid erase count) is 100,000, the valid erase count of 100,000 may be recorded as the first endurance data FE_data, at a predetermined address 123-1 in the memory unit 123.

The host controller 111 may transmit a power down signal (not shown) output from the internal circuit unit 113 to the semiconductor memory card 120 and may transmit a power down control signal PDCS to the power controller 117 when the second endurance data SE_data is completely stored in the memory unit 123 in the semiconductor memory card 120.

The second endurance data SE_data is a result of subtracting the number of erase operations, which are performed in the memory unit 123 during a given period (e.g., a period between when power starts to be supplied from the host 110 to the semiconductor memory card 120 and when the power is interrupted), from a value of the first endurance data FE_data. For example, when the valid erase count is 100,000 and the number of erase operations performed in the memory unit 123 during the given period is 1,000, the second endurance data SE_data has a value of 99,000.

According to an embodiment of the present invention, the first endurance data FE_data and the second endurance data SE_data are generated based on the number of erase operations performed in the memory unit 123. According to an embodiment of the present invention, the first endurance data FE_data and the second endurance data SE_data may be generated based on the number of program operations performed in the memory unit 123.

The memory controller 121 may transmit a second endurance data storage completion signal (not shown) to the internal circuit unit 113 when the second endurance data SE_data is completely stored in the memory unit 123. The second endurance data SE_data is stored in the semiconductor memory card 120 before the power supplied to the semiconductor memory card 120 is interrupted and the second endurance data SE_data is preserved. When the semiconductor memory card 120 is disconnected from the host 110, the erase count is accumulatively stored, and the life span of the semiconductor memory card 120 can be accurately calculated by a digital device to which the semiconductor memory card 120 is later connected.

The internal circuit unit 113 may generate the endurance data request signal ERS and the power down signal and receive the first endurance data FE_data or the second endurance data SE_data from the semiconductor memory card 120.

The display unit 115 displays the first endurance data FE_data or the second endurance data SE_data. A user can detect the erase count of the memory unit 123 based on the first endurance data FE_data or the second endurance data SE_data, which is displayed by the display unit 115, and move data stored in the memory unit 123 to another memory device before an erase count predetermined in the specification of the memory unit 123 is exceeded, thereby preserving the data safely.

The power controller 117 supplies a power supply voltage VCC to the semiconductor memory card 120 and may supply or interrupt the power supply voltage VCC to the semiconductor memory card 120 in response to the power down control signal PDCS generated by the host controller 111.

The semiconductor memory card 120 may be electrically connected to a memory slot (not shown) and store data (e.g., video data or audio data) output from the internal circuit unit 113 or transmit stored data to the internal circuit unit 113 via a card interface (not shown) implemented in the host 110.

The semiconductor memory card 120 may be a memory device embedded in the host 110. For example, when the host 110 is the MP3 player illustrated in FIG. 3C, the semiconductor memory card 120 may be a semiconductor memory device, e.g., a flash memory device, embedded in the MP3 player.

Alternatively, the semiconductor memory card 120 is a memory card and may be a compact flash card, a memory stick, a memory stick duo card, an MMC, a reduced MMC, an SD card, a mini SD card, a micro SD card (or a trans flash card), a smart card, an XD picture card or the like.

The semiconductor memory card 120 may include a power port input pin for receiving the power supply voltage VCC from the host 110, an address pin for receiving an address of data, a data input/output pin for receiving the data, and a command pin for receiving a command.

The memory controller 121 receives and updates the first endurance data FE_data, stores the updated data as the second endurance data SE_data, and transmits the stored second endurance data SE_data to the memory unit 121 or the host 110. The memory controller 121 may transmit the second endurance data SE_data to the memory unit 123 in response to the power down signal output from the host 110 and may transmit the second endurance data SE_data to the memory unit 123 every N erase operations (where N is a natural number, e.g., 10) in the memory unit 123.

The second endurance data SE_data is stored in the memory unit 123 before the power supplied to the semiconductor memory card 120 is interrupted, and the second endurance data SE_data is preserved. When the semiconductor memory card 120 is removed from the host 110, the erase count is accumulatively stored, and the life span of the semiconductor memory card 120 can be accurately calculated by a device to which the semiconductor memory card 120 is later connected.

The memory controller 121 may include a control unit 121-1 and an update unit 121-3. The control unit 121-1 may transmit the first endurance data FE_data or the second endurance data SE_data to the host 110 in response to the endurance data request signal ERS output from the host 110 and may transmit the second endurance data SE_data to the memory unit 123.

The update unit 121-3 may receive and update the first endurance data FE_data and store the updated data as the second endurance data SE_data. The update unit 121-3 may include an update circuit section 121-5 and a memory section 121-7.

The update circuit section 121-5 may receive and update the first endurance data FE_data and transmit the updated data as the second endurance data SE_data to the memory section 121-7 or the control unit 121-1. When an erase operation is performed in the memory unit 123, the update circuit section 121-5 may subtract a current erase count (e.g., 1,000), which increases with each performed erase operation, from the first endurance data FE_data (e.g., 100,000) and may generate and store data, which indicates a remaining erase count (e.g., 99,000) corresponding to a result of the subtraction, as the second endurance data SE_data. The update circuit section 121-5 may include a counter (not shown) and a subtractor (not shown) in order to subtract the current erase count from the first endurance data FE_data.

The memory section 121-7 is electrically connected with the update circuit section 121-5 and may store the first endurance data FE_data or the second endurance data SE_data. The memory section 121-7 may store the first endurance data FE_data and store data, which indicate the remaining erase count when the erase operation is performed in the memory unit 123, as the second endurance data SE_data.

The second endurance data SE_data generated in the update circuit section 121-5 is stored during a period between supply of the power to the semiconductor memory card 120 and interruption of the power, the memory section 121-7 may be implemented by non-volatile memory, which may be static random access memory (SRAM), dynamic random access memory (DRAM) or the like.

The memory unit 123 may store the first endurance data FE_data and store the second endurance data SE_data transmitted from the memory controller 121. The memory unit 123 may be implemented by a non-volatile memory device such as a mask ROM device, an EEPROM device, a flash memory device (e.g., a NOR flash memory device or a NAND flash memory device), an EPROM device or the like.

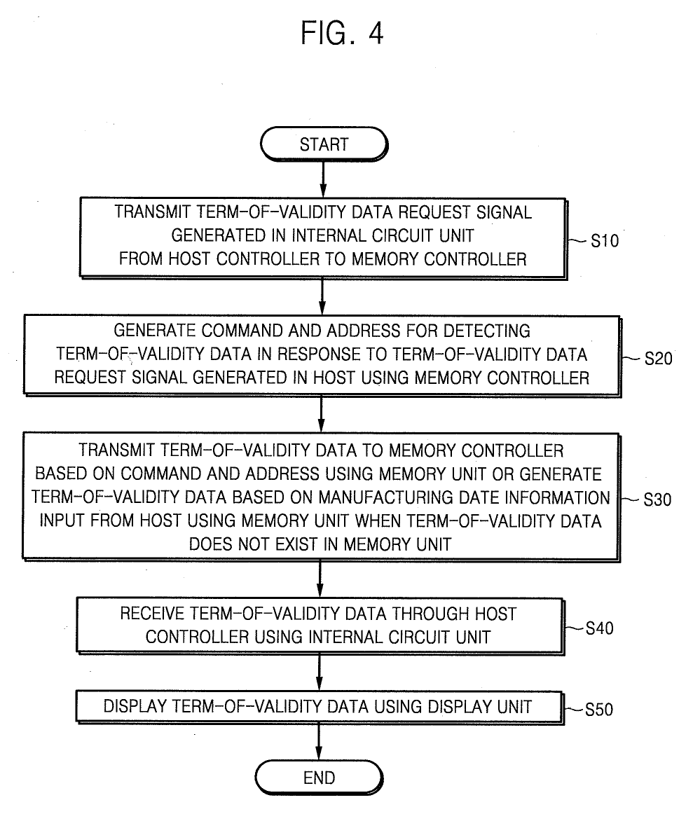

FIG. 4 is a flowchart of a method of providing term-of-validity data according to an embodiment of the present invention. Referring to FIGS. 1 and 4, in block S10, the host controller 21 transmits the term-of-validity data request signal VDRS generated in the internal circuit unit 23 to the memory controller 31. In block S20, the memory controller 31 generates a command and an address to detect the term-of-validity data VD in response to the term-of-validity data request signal VDRS. In block S30, the memory unit 32 detects the term-of-validity data VD based on the command and the address and transmits the term-of-validity data VD to the memory controller 31 or, when the term-of-validity data VD does not exist in the memory unit 32, generates the term-of-validity data VD by adding a used period, which is input through a user interface (not shown) or stored in the memory controller 31, to a manufacturing date based on manufacturing date information input through the user interface (e.g., a keyboard or a mouse) of the host 20. In block S40, the internal circuit unit 23 receives the term-of-validity data VD through the host controller 21. In block S50, the display unit 25 displays the term-of-validity data VD.

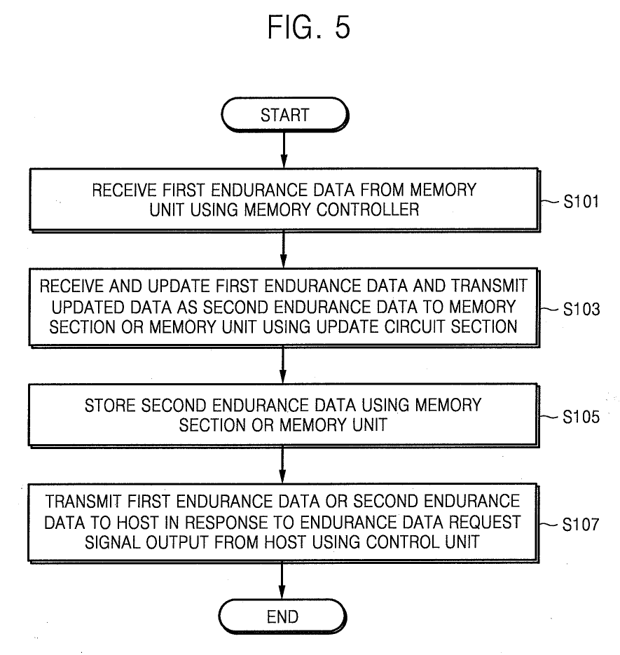

FIG. 5 is a flowchart of a method of providing endurance data according to some embodiments of the present invention. Referring to FIGS. 2 and 5, in block S101, the memory controller 121 receives the first endurance data FE_data from the memory unit 123. In block S103, the update circuit section 121-5 receives and updates the first endurance data FE_data and transmits the updated data as the second endurance data SE_data to the memory section 121-7 or the memory unit 123. In block S105, the memory section 121-7 or the memory unit 123 stores the second endurance data SE_data. In block S107, the control unit 121-1 transmits the first endurance data FE_data or the second endurance data SE_data to the host 110 in response to the endurance data request signal ER output from the host 110.

According to an embodiment of the present invention, a user can detect the term of validity, that is, how long a semiconductor memory card will be valid and move data in the semiconductor memory card to another memory device before the term of validity expires, thereby preserving the data. In addition, the user can also detect endurance data and thus move data stored in a memory unit to another memory device before a specified erase count is exceeded, thereby preserving the data.

While the present invention has been shown and described with reference to exemplary embodiments thereof, it will be understood by those of ordinary skill in the art that various changes in form and detail may be made herein without departing from the spirit and scope of the disclosure.

What is claimed is:

1. An electronic system including a semiconductor memory card, the semiconductor memory card comprising:
a memory unit configured to store term-of-validity data; and
a memory controller electrically connected with the memory unit and configured to transmit the term-of-validity data to a host in response to a term-of-validity data request signal output from the host.

2. The electronic system of claim 1, wherein the memory controller generates the term-of-validity data based on a manufacturing date input from the host when the term-of-validity data does not exist in the memory unit.

3. The electronic system of claim 1, further comprising:
a host,
wherein the host transmits a term-of-validity data request signal to the semiconductor memory card and receives the term-of-validity data.

4. The electronic system of claim 3, wherein the host comprises:
an internal circuit unit; and
a host controller configured to control data input/output between the internal circuit unit and the memory controller and to transmit the term-of-validity data request signal to the memory controller,
wherein the internal circuit unit is electrically connected with the host controller, generates the term-of-validity data request signal, and receives the term-of-validity data through the host controller.

5. The electronic system of claim 3, further comprising a display unit configured to display the term-of-validity data.

6. A method of providing term-of-validity data of a non-volatile memory, the method comprising:
generating a command and an address to detect term-of-validity data in response to a term-of-validity data request signal generated from a host, using a memory controller; and
performing one of detecting the term-of-validity data based on the command and the address, wherein the term-of-validity data is transmitted to the memory controller, and generating the term-of-validity data based on manufacturing date information input from the host, using a memory unit when the term-of-validity data does not exist in the memory unit.

7. The method of claim 6, further comprising:
transmitting the term-of-validity data request signal generated by an internal circuit unit to the memory controller, using a host controller, before the generation of the command and the address to detect the term-of-validity data; and
receiving the term-of-validity data through the host controller, using the internal circuit unit, after the generation of the term-of-validity data.

8. The method of claim 6, further comprising displaying the term-of-validity data using a display unit.

9. A semiconductor device comprising:
a memory unit configured to store first endurance data; and
a memory controller configured to receive and update the first endurance data, to store updated data as second endurance data, and to transmit the second endurance data to the memory unit or a host.

10. The semiconductor device of claim 9, wherein the memory controller comprises:
an update unit configured to receive and update the first endurance data and to store the updated data as the second endurance data; and
a control unit configured to transmit one of the first endurance data and the second endurance data to the host in response to an endurance data request signal output from the host and to transmit the second endurance data to the memory unit.

11. The semiconductor device of claim 10, wherein the update unit comprises:
a memory section configured to store one of the first endurance data and the second endurance data; and
an update circuit section configured to receive and update the first endurance data and to transmit the updated data as the second endurance data to the memory section or the control unit.

12. The semiconductor device of claim 10, wherein the first endurance data indicates the number of available erase operations that can be performed until a life span of the semiconductor device ends, and
wherein the second endurance data corresponds to a result of subtracting a number of erase operations performed in a given period from the first endurance data.

13. The semiconductor device of claim 9, wherein the memory controller transmits the second endurance data to the memory unit in response to a power down signal output from the host.

14. An electronic system comprising:
a memory card configured to update first endurance data and to store updated data as second endurance data; and
a host,
wherein the host transmits an endurance data request signal to the memory card and receives one of the first endurance data and the second endurance data.

15. The electronic system of claim 14, wherein the memory card comprises:
a memory unit configured to store the first endurance data; and
a memory controller configured to receive and update the first endurance data, to store the updated data as the second endurance data, and to transmit the second endurance data to the memory unit or the host.

16. The electronic system of claim 15, wherein the memory controller transmits the second endurance data to the memory unit in response to a power down signal output from the host.

17. The electronic system of claim 14, wherein the first endurance data indicates the number of available erase operations that can be performed until a life span of the memory card ends, and
wherein the second endurance data corresponds to a result of subtracting a number of erase operations performed in a given period from the first endurance data.

18. A method of providing endurance data of non-volatile memory, the method comprising the operations of:
receiving first endurance data from a memory unit, using a memory controller; and
receiving and updating the first endurance data, storing updated data as second endurance data, and transmitting the second endurance data to one of the memory unit and a host, using the memory controller.

19. The method of claim 18, wherein the operation of receiving and updating the first endurance data, storing the updated data, and transmitting the second endurance data comprises:
receiving and updating the first endurance data and transmitting the updated data as the second endurance data to one of a memory section and the memory unit, using an update circuit section;
storing the second endurance data using the memory section or the memory unit; and
transmitting one of the first endurance data and the second endurance data to the host in response to an endurance data request signal output from the host, using a control unit.
